(19) United States
(12) Patent Application Publication
(10) Pub. No.: US 2026/0274159 A1
(43) Pub. Date: Sep. 17, 2026

(54) WARNING DISPLAY SYSTEM FOR VEHICLES

(71) Applicants: Cyril Bernard KLECZEWSKI, Geva Binyamin (IL); Emma Emmanuelle KLECZEWSKI, Rishon LeTsion (IL)

(72) Inventors: Cyril Bernard KLECZEWSKI, Geva Binyamin (IL); Emma Emmanuelle KLECZEWSKI, Rishon LeTsion (IL)

(21) Appl. No.: 19/164,132

(22) PCT Filed: Mar. 13, 2024
(86) PCT No.: PCT/IL2024/050268

§ 371 Date: Sep. 10, 2025

(30) Foreign Application Priority Data
Mar. 15, 2023 (IL) 301415

(51) Int. Cl. B60Q 1/50; B60Q 1/26

(52) U.S. Cl. CPC B60Q 1/535; B60Q 1/2615; B60Q 1/5037

(57) ABSTRACT

A warning display system for vehicles, comprising a light projection system that is mounted on a rear region of a leading vehicle capable of traversing a road surface forwardly to a trailing vehicle and that is configured to project emitted light onto the road surface so as to generate a warning image visible to a driver of the trailing vehicle externally to the trailing vehicle, when the trailing vehicle approaches the leading vehicle at a distance less than predetermined proximity corresponding to a given speed of the trailing vehicle, of the leading vehicle and the acceleration of the distance between them.

### FIELD OF THE INVENTION

The present invention relates to the field of vehicular safety. More particularly, the invention relates to a warning display system for vehicles that are driving dangerously close to a leading vehicle. The warning display system is adapted to be mounted on the rear region of the leading vehicle.

### BACKGROUND OF THE INVENTION

A major drawback of the existing driver assistance systems is the fact that such systems are devoted to the vehicle they are mounted on. For example, when a trailing vehicle doesn't have such a driver assistance system, the leading vehicle lacks protection from this trailing vehicle.

Many driver assistance systems include a forward collision warning system that is based on a vehicle mounted camera or radar for providing obstacle detection and a processor for processing information obtained from successive images acquired by the camera to estimate a time-to-contact value with an obstacle, particularly a leading vehicle. Such systems, however, are dependent upon acquiring discernable images of the obstacle by the camera, and a reliable warning cannot be generated during periods of poor visibility, such as during the occurrence of heavy fog or of a snowstorm. Another serious deficiency of known driver assistance systems is the distraction to the driver that is caused by the displayed warning, leading to a life endangering event rather than a life-saving event as intended by the driver assistance system.

It is an object of the present invention to provide a display system for generating a warning for the driver of a trailing vehicle that is indicative of driving dangerously close to a leading vehicle and that is ensured of being displayed during periods of both good and poor visibility.

It is an additional object of the present invention to provide a warning display system for vehicles which is configured to generate a displayed warning that is assured of not distracting the driver.

Other objects and advantages of the invention will become apparent as the description proceeds.

### SUMMARY OF THE INVENTION

A warning display system for vehicles comprises electronic equipment configured for displaying a warning image visible to a driver of a trailing vehicle, wherein said electronic equipment mounted on a rear region of a leading vehicle. In one aspect, the electronic equipment comprises a display screen and a light projection system.

In one aspect, the system further comprises safety circuitry configured to generate an on-board warning image or warning message when the trailing vehicle is distanced from the leading vehicle at a distance less than the predetermined proximity.

In one aspect, the light projection system and the display screen combined to form a single console suitable to be mounted behind the rear window of the leading vehicle

In another aspect, a warning display system for vehicles comprises a light projection system that is mounted on a rear region of a leading vehicle capable of traversing a road surface forwardly to a trailing vehicle and that is configured to project emitted light onto the road surface so as to generate a warning image visible to a driver of the trailing vehicle externally to the trailing vehicle, when the trailing vehicle approaches the leading vehicle at a distance less than a predetermined proximity corresponding to a given speed of the trailing vehicle, its distance from the leading vehicle and the relative speed between them.

The generated warning image is representative of a virtual safe driving boundary which divides the road surface into a first area that is a safe driving region and a second area within which the trailing vehicle is subject to collision-liable conditions upon passing the boundary. According to an embodiment of the invention, the second area is the one that is closer to the leading vehicle and the first area is farther from the leading vehicle.

In one aspect, the light projection system comprises one or more light emitters, a corresponding driver for said one or more light emitters, and means for displacing said one or more light emitters in response to a detected proximity severity level between the trailing vehicle and the leading vehicle so that an appearance of the generated warning image will be indicative of the detected proximity severity level.

In one aspect, the light projection system further comprises a controller configured to command operation of the corresponding driver in response to a received proximity severity level indication.

In one aspect, the warning display system further comprises a time of flight system by which the controller receives the proximity severity level indication.

In one aspect, the time of flight system comprises a time of flight sensor for measuring an instantaneous distance between the leading vehicle and the trailing vehicle in terms of speed and acceleration of both vehicles, a processor for processing signals generated by the time of flight sensor to determine an instantaneous distance between the leading vehicle and the trailing vehicle and a corresponding proximity severity level, and a short range transmitter for transmitting a signal which is representative of the proximity severity level to the controller.

In one aspect, the time of flight sensor comprises an emitter from which a beam of light is emitted rearwardly and a receiver for receiving the reflected light after impinging the trailing vehicle, the instantaneous distance between the leading vehicle and the trailing vehicle being based on a propagation time of photons from the time of flight sensor emitter to the trailing vehicle and in return from the trailing vehicle to the receiver.

In one aspect, the displacing means comprises an inclination mechanism for adjusting an inclination of each of the one or more light emitters relative to a horizontal plane.

In one aspect, each of the one or more light emitters has a planar surface that is kinematically connected to the inclination mechanism.

In one aspect, the inclination mechanism comprises a pivotal connection by which the planar surface of each of the light emitters is pivotally connected to a horizontal casing surface, a linear actuator that is linearly displaceable along a plane parallel to the casing surface, a motor for driving the linear actuator, and a rod movably engaged with the linear actuator and pivotally connected to an intermediate region of the light emitter that causes an adjustment of an angle of the light emitter relative to the casing surface in response to displacement of the linear actuator.

In one aspect, the warning display system further comprises a bilateral control algorithm, configured to improve traffic conditions based on real-time traffic data and the speeds of both vehicles, thereby creating a “moving buffer zone” that adapts to changing traffic conditions to mitigate traffic congestion, wherein said improvement in traffic conditions occurring even without direct communication to the trailing vehicle, as the warning display system encourages the driver of the trailing vehicle to constantly keep the optimal distance to the vehicle in front of him according to the driving conditions.

### BRIEF DESCRIPTION OF THE DRAWINGS

In the drawings:

FIG. 1 is a perspective view of a warning image that is displayed on a road surface between a leading vehicle and a trailing vehicle, as well as a warning message displayed on a rear-mounted screen;

FIG. 2 is a schematic illustration of an embodiment of a light projection system for projecting the warning image of FIG. 1; and

FIG. 3 is a schematic illustration of a time of flight system that is in data communication with the light projection system of FIG. 2.

### DETAILED DESCRIPTION OF THE INVENTION

In contrast to in-vehicle warning systems by which a visual or audible signal is generated within a trailing vehicle when the trailing vehicle is dangerously close to a leading vehicle, the warning system of the present invention generates a warning image from the leading vehicle that is visible to the driver of the trailing vehicle on the road surface externally to the trailing vehicle, both during good and poor visibility conditions. According to an embodiment of the invention, the warning system comprises electronic equipment mounted on a rear region of the leading vehicle and configured for displaying the warning image to the driver of a trailing vehicle, thus the warning image can be generated by a light projection system, as well as on a display screen. For example, the light projection system and the display screen can be integrated to form a single console suitable to be mounted behind the rear window of the leading vehicle. This warning image indicates a virtual safe driving boundary which divides the road into a first area that is a safe driving region and a second area within which the trailing vehicle is subject to collision-liable conditions upon passing the boundary. The first area is farther from the leading vehicle and the second area is closer to the leading vehicle. The sudden appearance of the warning image generally triggers an instinctive reaction of the driver of the trailing vehicle to reduce speed (e.g., by slightly releasing the gas pedal or by pressing on the brakes pedal) and to be distanced from the safe driving boundary. As the warning image appears on the road surface to the front of the trailing vehicle, the driver of the trailing vehicle is not distracted, and the sudden appearance of the warning image will not ordinarily cause the driver of the trailing vehicle to swerve or make any other erratic driving motions.

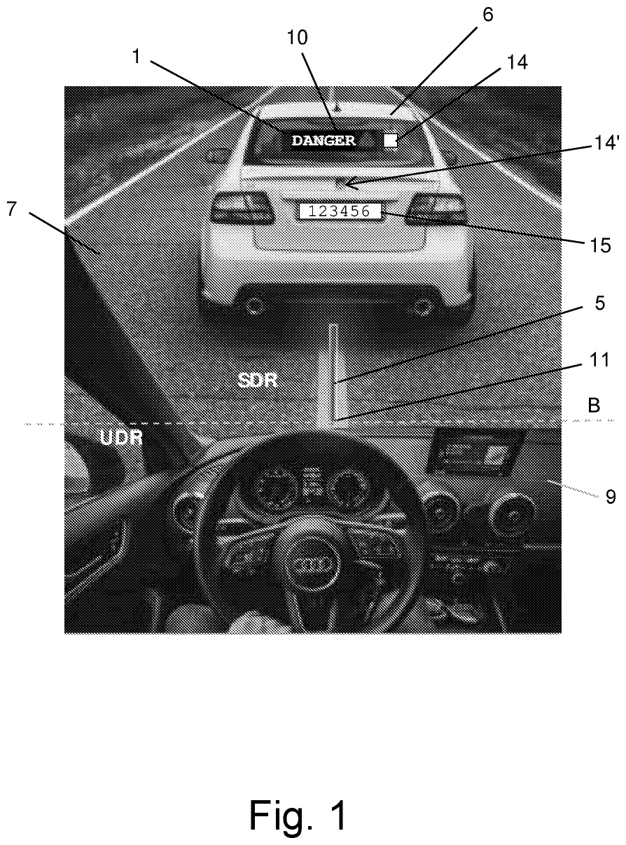

FIG. 1 illustrates a warning image 5 that is displayed on a road surface 7, according to one embodiment. As shown, warning image 5 is a coherent light beam, for example a laser beam, which is irradiated from a low-profile light projection system 14 mounted at the rear of leading vehicle 6 as a warning for trailing vehicle 9 traversing road surface 7 immediately after leading vehicle 6. The terminal end 11 of warning image 5, which is adapted to impinge road surface 7, defines a virtual safe driving boundary B. The driver of trailing vehicle 9, upon suddenly viewing warning image 5, intuitively understands that a safe driving region (SDR) is defined between boundary B and trailing vehicle 9 and that an unsafe driving region (UDR) is defined between boundary B and leading vehicle 6, and is required to reduce speed to avoid entering the UDR and risking a collision. The intensity of the light beam is generally selected to be sufficiently high in order to ensure that it will be readily seen by the driver of trailing vehicle 9 during periods of poor visibility. According to an embodiment of the invention, the intensity of the light beam can be adjusted dependent on the visibility or weather conditions (e.g., the intensity can be adjusted based on reading received from one or more intensity sensors).

According to an embodiment of the invention, low-profile light projection system 14 is combined with a display screen 10 to form a single console 1. For example, console 1 can be mounted behind the rear window of leading vehicle 6, as shown in FIG. 1. According to some embodiments of the invention, low-profile light projection system 14 and display screen 10 are separated units, and each may be located in a different location of leading vehicle 6. For example, low-profile light projection system 14 can be located adjacent to a license plate 15 of leading vehicle 6, as indicated by arrow 14′.

Warning image 5 is indicative of the proximity severity level between trailing vehicle 9 and leading vehicle 6. The warning level may not be displayed when trailing vehicle 9 is at a safe distance significantly behind leading vehicle 6, but is adapted to be displayed when the trailing vehicle increases its speed relative to the leading vehicle. The color of warning image 5 may change in response to the proximity severity level, for example from a first color such as green when the trailing vehicle is approaching the leading vehicle to a second color such as red when the trailing vehicle is dangerously close to the leading vehicle. In another example, three colors can be used as follows: green safe, orange approaching the dangerous area, and red inside the dangerous area. Warning image 5 may have a predetermined length that is dependent upon the speed of leading vehicle 6 and of trailing vehicle 9 and upon the proximity of trailing vehicle 9 relative to leading vehicle 6.

Warning image 5 may appear on road surface 7 in various ways, for example as the illustrated light beam that appears to be stationary to the driver of the trailing vehicle, although it may change colors in accordance with the proximity between the leading and trailing vehicles. In other embodiments, the warning image may be appearing to be dynamic, moving along the road surface, such along a travel direction or from side to side. Also, the warning image may be generated as a more complex image than a light beam, such as a composite image having more than one color or more than one shape.

The following description relates to a light projection system for generating a warning image in the form of a light beam, but it will be appreciated that the light projection system is able to be modified mutatis mutandis in order to generate any other type of warning image.

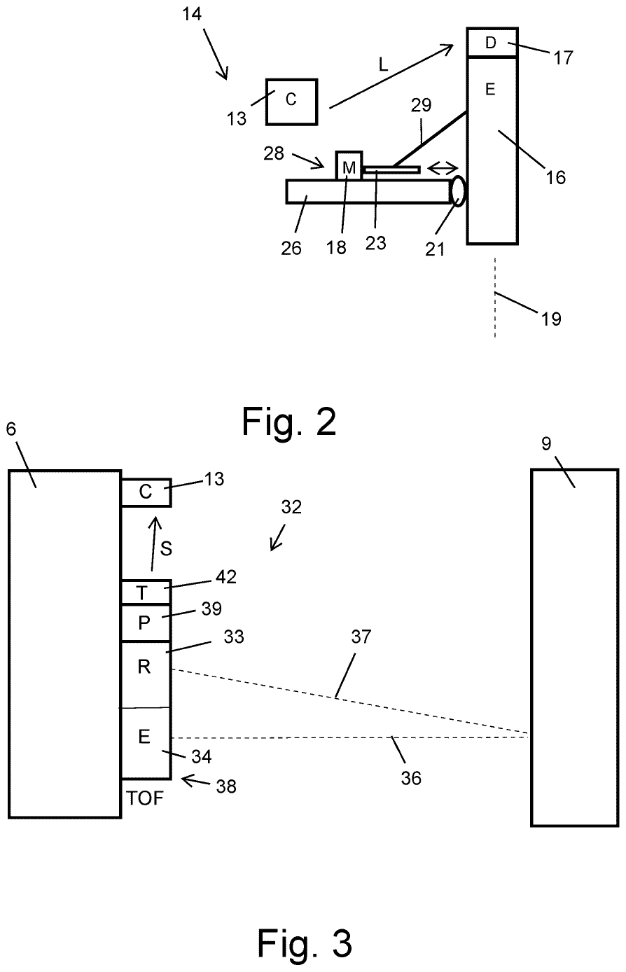

The warning image may be generated by a low-profile light projection system 14 schematically illustrated in FIG. 2, for example enclosed in a casing (not shown) with a thickness of no more than 5 mm that is mounted at the rear of the trailing vehicle, for example close to the license plate.

Light projection system 14 according to one embodiment comprises one or more light emitters 16, e.g. laser emitters, each configured to emit a beam of coherent light at a predetermined wavelength by means of corresponding drivers 17. Each driver 17 provides suitable injection current, for example operating in constant current, constant power or variable intensity modes. Each light emitter 16, which is preferably angularly displaceable, or which may be displaceable by other means, in order to change the appearance of the warning image in response to the proximity severity level between the trailing vehicle and the leading vehicle, has a planar surface that is kinematically connected to an inclination mechanism 28. Beam 19 is emitted from a bottom region of the corresponding emitter 16 at an angle in accordance with its inclination. A controller 13 commands operation of each driver 17 by means of a signal L in response to a received proximity severity level indication.

A single driver 17 may be operated at any given time in order to generate a corresponding single-color image, which may be changed in response to the proximity severity level. Alternatively, more than one driver may be simultaneously operated in order to generate a multi-color image.

In one embodiment, inclination mechanism 28 comprises a pivotal connection 21 by which the planar surface of light emitter 16 is pivotally connected to horizontal casing surface 26, a linear actuator 23 such as a worm drive that is linearly displaceable along a plane parallel to surface 26, a motor 18 for driving linear actuator 23 such as by rotatably driving the linear actuator, and a rod 29 movably engaged with linear actuator 23 and pivotally connected to an intermediate region of light emitter 16. The angle of light emitter 16 relative to surface 26 is adjusted in response to displacement of linear actuator 23, causing in turn a change in the appearance of the warning image. The stator of motor 18, for example a stepper motor, may be fixed to the casing or to the vehicle body.

Motor 18 may be variably and controllably operated in order to generate a dynamic warning image.

In another embodiment, inclination mechanism 28 comprises a shaft on which a plurality of light emitters at different axial locations are mounted. Each light emitter at the same axial location may emit a same color light. The angle of each light emitter and of the light beam emitted thereby relative to a vertical plane is adjusted upon rotation of the shaft by a predetermined angle.

FIG. 3 schematically illustrates a time of flight (TOF) system 32 by which controller 13 receives a proximity severity level indication.

TOF system 32 is provided at the rear of the leading vehicle 6, and is adapted to measure the time that light is reflected from a detected trailing vehicle 9. TOF system 32 is generally housed in a separate casing than that of the light projection system, although it may be housed in the same casing.

As shown, TOF system 32 comprises a TOF sensor 38 configured with an emitter 34 from which a beam of light 36, whether laser light or LED light, is emitted rearwardly and with a receiver 33 for receiving the reflected light 37 after impinging the trailing vehicle. TOF sensor 38 measures the instantaneous distance between the leading vehicle and the trailing vehicle based on the propagation time of photons from emitter 34 to trailing vehicle 9 and in return from trailing vehicle 9 to receiver 33, usually in conjunction with a clock signal. The emitted light 36 may propagate through a first aperture formed in the casing of TOF system 32, and the reflected light 37 may pass through a second aperture. Alternatively, both the emitted light 36 and the reflected light 37 may propagate through the same aperture formed in the casing of TOF system 32.

TOF sensor 38 may be a direct TOF sensor whereby short pulses of light, each having a duration of only a few nanoseconds, are emitted, and then the reflected light pulses are received after a time of flight. Alternatively, TOF sensor 38 may be an indirect TOF sensor whereby continuous and modulated light is emitted, and the phase of the reflected light is measured to calculate the instantaneous distance to trailing vehicle 9.

TOF system 32 also comprises a processor 39 for processing signals generated by receiver 33 to determine the instantaneous distance between the leading vehicle and the trailing vehicle and the corresponding proximity severity level, and a short range transmitter 42 for transmitting a signal S which is representative of the proximity severity level to the controller 13 of the light projection system. Controller 13 in turn commands operation of the light projection system in response to the transmitted signal P.

In another embodiment, a warning image visible to the driver of the trailing vehicle is displayed on the body of the leading vehicle when the trailing vehicle approaches the leading vehicle at a distance less than a predetermined proximity corresponding to a given speed of the trailing vehicle. A typical warning image is a text message that is indicative of the excessive proximity to the leading vehicle and that the trailing vehicle should reduce its speed. The vehicle-displayed warning image may be displayed on a display device mounted on the rear windshield, the rear license plate or any other suitable vehicular portion of the leading vehicle, by means of suitable safety circuitry such as in conjunction with an optical connection between the leading and trailing vehicles. An exemplary optical connection between the leading and trailing vehicles is an image of the license plate of the trailing vehicle captured by a rearwardly facing imager mounted on the leading vehicle. The captured image may be wirelessly transmitted to a law enforcement agency if the trailing vehicle stayed too close to the leading vehicle for too long.

In another embodiment of the invention, the system incorporates an innovative use of a vehicle's standard rear license plate as a dynamic display device for conveying safety warnings to the driver of a trailing vehicle. This embodiment leverages the rear license plate, which, under normal circumstances, displays the vehicle's registration number, as a multifunctional display capable of showing critical warning messages when necessary. For example, in such embodiment, the rear license plate is equipped with an electronic display capable of operating in two modes. In its default mode, it functions as a conventional license plate displaying the vehicle's registration number. In its warning mode, it switches to display a safety warning message directed at the trailing driver. In this embodiment, the system is designed to automatically switch the license plate display from its default mode to the warning mode when the sensors detect a trailing vehicle approaching at a distance less than a predetermined proximity, which is deemed unsafe based on the speed of the trailing vehicle. Upon activation of the warning mode, the license plate display may temporarily replace or superimpose the registration number with a warning message. This message alerts the trailing driver of the excessive proximity and advises reducing speed to prevent potential hazards. The warning message is designed to be clear and easily understandable to ensure immediate recognition and response from the trailing driver.

The safety circuitry may be electrically connected to the on-board diagnostics (OBD) system of the vehicle within which it is installed and may cause the hazard lights to automatically flash when the trailing car is excessively close to the leading vehicle. The safety circuitry may be configured to limit the speed of the trailing vehicle, if such a system is installed on it too, when excessively close to the leading vehicle. An audible warning message may also be transmitted to the driver of the trailing vehicle or of the leading vehicle, such as to a Bluetooth-accessible phone application, when the leading and trailing vehicles are excessively close.

The vehicle-displayed warning image may be in addition or in substitute to a road-displayed warning image, according to any embodiment described herein.

According to an embodiment of the invention, the warning display system can be utilized for Traffic Congestion Mitigation (TCM). This embodiment aimed at mitigating traffic congestion, a bilateral control algorithm can be integrated into the warning display system for vehicles of the present invention. This feature works in tandem with the light projection system and the display screen to not only warn the trailing vehicle but also to actively manage the traffic flow. When the Time of Flight (TOF) system detects that the trailing vehicle is within certain proximity, the bilateral control algorithm activates.

Importantly, this system improves the traffic situation even without direct communication to the trailing vehicle. This is achieved through the warning display system of the invention, which encourages the rear driver to constantly keep an optimal distance to the vehicle in front of him according to the driving conditions. By doing so, the system inherently mitigates traffic congestion by promoting a more uniform flow of vehicles.

According to an embodiment of the invention, the bilateral algorithm aims to create a “moving buffer zone” that adapts to changing traffic conditions, effectively maintaining a balanced distance between multiple vehicles. This moving buffer zone helps to prevent the ripple effect commonly seen in stop-and-go traffic, thereby further mitigating traffic congestion. The system can also optionally communicate with other similarly equipped vehicles to create a network of cars all maintaining optimal distances from each other, further enhancing traffic flow.

This traffic congestion mitigation embodiment can either be an optional feature that drivers activate during high-traffic conditions or be automatically triggered when the system detects congestion. This provides a multi-layered approach to both individual vehicle safety and broader traffic management issues.

According to an embodiment of the invention, the TCM can be implemented by integrating both relative speed and acceleration measurements into the distance monitoring system between vehicles. This integration offers a more comprehensive understanding of the real-time context of vehicle proximity, thereby significantly enhancing road safety and traffic flow. The system analyzes data in real-time with respect to relative speed, acceleration, and distance. It may employ algorithms suitable to assess the dynamic relationship between vehicles based on their relative speed, acceleration, and distance. The warning display system alerts drivers of potential hazards based on the analysis. The display adapts its warnings and recommendations to the current driving conditions, guiding drivers to maintain safe distances and speeds. The system continuously collects data on the relative speed, acceleration, and distance between vehicles, and analyzes the data in real-time to assess the risk levels based on the vehicles' proximity dynamics. This analysis considers the rate at which vehicles are approaching or moving away from each other, factoring in their acceleration to predict potential hazards. Based on the analysis, the system generates alerts and recommendations for the driver. These alerts aim to inform the driver about the optimal distance and speed to maintain relative to the vehicle ahead, considering the current driving conditions.

By providing a more nuanced assessment of vehicle proximity and potential hazards, the system significantly reduces the likelihood of accidents, and promotes consistent vehicle spacing, preventing the stop-and-go patterns that often lead to congestion, thereby enhancing traffic efficiency. Moreover, the warning display provides tailored recommendations to drivers, encouraging safer driving behaviors without the need for direct vehicle-to-vehicle communication.

The integration of relative speed and acceleration measurements into vehicular distance monitoring represents a significant advancement in automotive safety systems. By offering a more detailed perspective on the dynamics of vehicle proximity, the invention not only enhances road safety but also contributes to smoother traffic flow, marking a significant step towards safer and more efficient roadways.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A warning display system for vehicles, comprising electronic equipment configured for displaying a warning image visible to a driver of a trailing vehicle, the electronic equipment mounted on a rear region of a leading vehicle;
wherein the system is configured to generate the warning image when the trailing vehicle approaches the leading vehicle at a distance less than a predetermined proximity, the predetermined proximity being dynamically determined based on the speed of the trailing vehicle, the speed of the leading vehicle, and the acceleration of the distance between them;
the system further comprising a time-of-flight (TOF) system including a sensor and a processor configured to determine an instantaneous distance between the vehicles and a corresponding proximity severity level, and a short-range transmitter configured to transmit a signal representative of the proximity severity level to a controller;
wherein the controller is configured to command operation of the electronic equipment in response to the transmitted signal; and
wherein an appearance of the warning image is indicative of the proximity severity level, and a length and/or position of the warning image is dependent upon the speeds of the vehicles and the proximity.

2. The system of claim 1, wherein the warning image is not displayed when the trailing vehicle is at a safe distance significantly behind the leading vehicle, and is displayed when the trailing vehicle increases its speed relative to the leading vehicle.

3. The system of claim 1, wherein the electronic equipment comprises a display screen.

4. The system of claim 1, wherein the electronic equipment comprises a light projection system configured to project emitted light to generate the warning image.

5. The system of claim 4, wherein the light projection system and a display screen are combined to form a single console adapted to be mounted behind a rear window of the leading vehicle.

6. The system of claim 4, wherein the light projection system and a display screen are separated units each located at a different location of the leading vehicle.

7. The system of claim 1, wherein the TOF system is housed in a separate casing from that of the light projection system.

8. The system of claim 1, wherein the TOF sensor comprises an emitter to emit light rearwardly and a receiver to receive reflected light from the trailing vehicle, the instantaneous distance being based on a time-of-flight propagation time.

9. The system of claim 4, wherein a terminal end of the warning image defines a virtual safe-driving boundary.

10. The system of claim 4, wherein the light projection system comprises one or more light emitters, a corresponding driver, and an inclination mechanism for adjusting an inclination of each light emitter relative to a horizontal plane.

11. The system of claim 10, wherein each light emitter has a planar surface kinematically connected to the inclination mechanism.

12. The system of claim 10, wherein the inclination mechanism comprises a pivotal connection, a linear actuator, a motor, and a rod movably engaged with the linear actuator and pivotally connected to an intermediate region of the light emitter.

13. A method of warning a trailing vehicle, comprising:
generating, by electronic equipment mounted on a rear region of a leading vehicle, a warning image visible to a driver of the trailing vehicle;
measuring an instantaneous distance between the vehicles with a time-of-flight sensor and processing signals with a processor to determine a proximity severity level as a function of the speeds of the vehicles and the acceleration of the distance between them;
transmitting a short-range signal representative of the proximity severity level to a controller; and
commanding operation of the electronic equipment in response to the transmitted signal such that an appearance of the warning image is indicative of the proximity severity level, and a length and/or position of the warning image is dependent upon the vehicles' speeds and proximity, the warning image being generated when the trailing vehicle approaches the leading vehicle at a distance less than the predetermined proximity.

14. The method of claim 13, wherein the warning image is not displayed when the trailing vehicle is at a safe distance significantly behind the leading vehicle and is displayed when the trailing vehicle increases its speed relative to the leading vehicle.

15. The method of claim 13, further comprising projecting the warning image with a light projection system so that a terminal end of the image defines a virtual safe-driving boundary.

16. The method of claim 13, wherein the electronic equipment comprises a display screen on which the length and/or position of the warning image is dependent upon the vehicles' speeds and proximity.

17. The method of claim 13, wherein displaying the warning image comprises rendering, on a display device mounted on the rear license plate of the leading vehicle, a default registration number, and switching to a warning message when the trailing vehicle approaches the leading vehicle at a distance less than the predetermined proximity, the warning message temporarily replacing or being superimposed on the registration number.

18. A warning display system for vehicles, comprising a display screen that is combined with a light projection system to form a console adapted to replace its rear vehicle registration plate, the console being configured to display a warning image visible to a driver of a trailing vehicle when the trailing vehicle approaches the leading vehicle at a distance less than a predetermined proximity determined as a function of the speeds of the vehicles and the acceleration of the distance between them;
the system further comprising a time-of-flight system including a sensor, a processor configured to determine an instantaneous distance and a proximity severity level, and a short-range transmitter configured to transmit a signal representative of the proximity severity level to a controller that commands operation of the console in response to the transmitted signal; and
wherein an appearance of the warning image is indicative of the proximity severity level and a length of the warning image is dependent upon the speeds of the vehicles and the proximity.

19. The system of claim 19, wherein the console is configured to operate in two modes, including a default mode and a warning mode, wherein in the default mode the console displays a vehicle registration number and in the warning mode the console displays a safety warning image or message, wherein the console automatically switches from the default mode to the warning mode when the trailing vehicle approaches the leading vehicle at a distance less than the predetermined proximity.

20. The system of claim 19, wherein the safety warning image or message temporarily replaces the vehicle registration number, or is superimposed on the vehicle registration number.
